(19) United States
(12) Patent Application Publication
(10) Pub. No.: US 2006/0180949 A1
(43) Pub. Date: Aug. 17, 2006

(54) Impeller draft tube, shroud, impeller and aerator

(76) Inventors: Gerrit Beusekom, Coalhurst (CA); Bert Van Hierden, Coaldale (CA)

Correspondence Address: ROBERT W.B. BAILEY, BOX 2, STATION L, WINNIPEG, MB, R3H 0Z4, CA

(21) Appl. No.: 11/058,169

(22) Filed: Feb. 16, 2005

(51) Int. Cl. B01F 3/04

(52) U.S. Cl. 261/93; 261/120

(57) ABSTRACT

A shroud for an impeller used for aeration of contaminated water, has a front portion for a propeller, behind it is a rear portion with separate apertures for water and air, the air aperture accommodates the propeller shaft. A draft tube connected to the shroud has a stub tube at the rear end for air ingress. The propeller shaft passes through the draft tube, and a bearing box to a motor. The draft tube has a rear attachment plate to which the bearing box is attached. The bearing box has a bearing for the shaft held in place by a retainer, it also is attached at its rear to a motor mounting plate, on which the motor is mounted. The impeller is mounted on a swivel arm mounted pivotally on a frame, typically on a raft. The swivel arm allows the impeller to be positioned angularly and lockably in a plurality of angular positions from horizontal to vertical.

### FIELD OF THE INVENTION

This invention relates to an impeller shroud, for a propeller, the shroud allows some water to flow over the propeller. The shroud is mounted on a draft tube, which allows both a propeller shaft to rotate the propeller and air to enter the shroud. The arrangement aerates water, especially contaminated water, and speeds aerobic digestion or decomposition of the contaminants. It is believed that this is achieved by micro sized air bubbles generated by the impeller, which maximizes absorption of air into the water. The shroud has apertures allowing water to be drawn into the shroud, where the propeller is believed to cavitate the water creating a strong vacuum which draws air down the draft tube into the propeller which mixes the air and water uniformly. The propeller then propels the air water mixture into the surrounding water causing a gentle mixing action. The propeller shaft is attached by a bearing box to a motor. Preferably the device is mounted on a frame attached to a float or floats. In use it aerates water, such as but not limited to hog barn effluent and other lagoons for industrial effluents. Application of such aerators greatly reduces the smell and effluents present, to such an extent that complaints about smell vanish, the water in the lagoons is odorless and usable for industrial applications. It is conjectured that this is due to the aerator supplying air and oxygen to satisfy biological oxygen demand and prevent or reduce anaerobic digestion and decomposition. An aerator incorporating shroud and propeller is environmentally beneficial in that it reduces the effects of pollution and contamination.

### PRIOR ART

Aerators are known. An aerator is known locally to applicant of which only a single example exists without printed publication, which has a shroud with a rear aperture for a shaft to rotate a propeller, parallel to the shaft are two pipes or tubes to support the shroud and two bearings for the shaft. One tube has an end bend connecting through an aperture to the shroud to supply air down the tube, water is supplied through the shaft aperture. Two transverse plates welded to the tubes have the shaft bearings bolted to them. A motor drives the shaft mounted on the longer air supplying tube, which itself is mounted on another pipe pivoted on a frame connecting two pontoons. The motor was coupled to the shaft by a rubber coupling. When tested this aerator was less effective than current invention, probably because the propeller suction was less effective down the side tube, dissolving less air. It also vibrated substantially wearing the bearings so they needed replacement every seven or eight weeks or two months. The device also seized when the temperature fell below −7 or −8° C. There was substantial room for improvement.

The problem with lagoons used to store pollutants and contaminants is that generally the initial aerobic digestion or decomposition removes the dissolved oxygen from the lagoon water and anaerobic digestion or decomposition begins, the products of anaerobic decomposition often include vapors and gasses of horrible odor. It is known that aeration both stops anaerobic digestion and decomposition and encourages and initiates aerobic digestion and decomposition. Obviously a steady supply of oxygen is required to maintain dissolved oxygen for aerobic digestion or decomposition. Typically it is provided by passing air through the water, where it dissolves. Many such devices have been patented and many are commercially available.

Applicants had a 2½ million gallon (11 million liter) lagoon which was used for waste water from a truck wash. It produced a horrible odor which was a nuisance and made applicants very unpopular with the local community. Two devices of the present invention were installed and within fourteen days, the smell had vanished and the lagoon water seemed clean, at least for washing, solving applicants' problem, and improving local community relations. Local authorities using a crude quantitative test rated the treated lagoon odor as 1, acceptable, at the edge of the lagoon, roughly 0 is no noticeable smell, 10 is the maximum detectable, hog barn lagoons rate between 7 and 8.

In a separate instance, a hog barn stage-one lagoon for liquid excrement after removal of solids from 4,000 hogs and 100 dairy cattle, flow estimated at 80,000 gallons every two weeks, was treated with three aerators of the invention. Previously there were intense odors and endless complaints from neighbours. Within seven days of installation of the aerators of the invention, there was very little noticeable odor around the lagoon, within fourteen days the odor was almost completely eliminated. Further there are now no complaints from neighbours. Not only did the odor vanish for practical purposes, but the sludge build up around the outside edge of the lagoon had disappeared and the liquid of the lagoon itself was much cleaner. Previously two other types of aerators were tried by comparison only the aerators of the invention were effective. One ½ horsepower aerator tested had no effect. The other aerator, which had the same horsepower, 5, as applicants' aerator, did far less than applicants' aerator, and used three times as much electricity.

### BRIEF SUMMARY OF THE INVENTION

In view of the observed deficiencies of commercially available prior art aeration devices, the present invention provides a new impeller shroud for aeration devices for industrial waste water lagoons. The shroud has a front aperture for outward aerated water flow and rear apertures for inward water access. It is also connected to a draft tube which has an aperture for inward air access. When assembled a propeller rotates in the shroud, driven by a propeller shaft passing through the draft tube. The propeller sucks water in through the rear apertures, which cavitates in the shroud and sucks air down the draft tube to produce microbubbles of air which dissolve in the water. The absence of a shaft or propeller bearing in the shroud is significant because otherwise the suction effect of the propeller would be eliminated or at least greatly reduced. The aerated water then mixes smoothly with the water in the lagoon. The shroud draft tube has an aperture for air access, and a motor connected through a bearing box to the propeller shaft. Preferably the draft tube-motor assembly is mounted on a frame so that the propeller impeller is submerged in the water, while the draft tube aperture, bearing box and motor are in the air. Preferably the device is mounted on a frame, which may be pivotable from a horizontal position above water, to an angled position with propeller and shroud submerged. The frame may be mounted on a raft, which may include floats. Generally the motor is electric, although it is not so limited, and may be connected by an electric cable to a power supply. The cable may extend to the raft, which is typically moored in a lagoon, although not so limited.

There has thus been outlined, rather broadly, the more important features of the invention in order that the description thereof may be better understood, and in order that the present contribution to the art may be better appreciated. There are additional features of the invention that will be described hereinafter and that will form the subject matter of the claims appended thereto.

In this respect, before explaining at least one embodiment of the invention in detail, it is to be understood that the invention is not limited in its application to the details of construction and to the arrangement of the components set forth in the following description or illustrated in the drawings. The invention is capable of other embodiments and of being practised and carried out in various ways. Also, it is to be understood that the phraseology and terminology employed herein are for the purpose of the description and should not be regarded as limiting.

It is a principal object of the invention to provide a shroud for a propeller that overcomes the shortcomings of prior art aerators. It is a principal object of the invention to provide a shroud with a front aperture for outward aerated water flow and rear apertures for inward water access. It also a principal object to provide a shroud with a rear draft tube allowing inward air access. It is a further principal object of the invention that the draft tube provides access for a propeller shaft to rotate a propeller within the shroud. It is a further principal object to provide that rotation of the propeller within the shroud, sucks water through the rear shroud aperture and sucks air down the draft tube and expels aerated water from the forward aperture of the shroud. It is a subsidiary object that the propeller cavitates the water in the shroud and sucks air down the draft tube into the cavitating water to produce microbubbles of air which dissolve in the water. It is a further principal object of the invention to provide no propeller bearing or shaft bearing in the shroud and draft tube, to affect, reduce or eliminate the suction effect of the propeller in the shroud. It is a further principal object of the invention to provide aerated water which mixes smoothly with the water surrounding the shroud. It is a further object of the invention to provided an air access aperture in the draft tube. It is a further subsidiary object of the invention to provide a motor to drive said propeller shaft. It is also a further subsidiary object of the invention to provide a bearing box to connect the motor to the propeller shaft. It is a subsidiary object to provide a frame to mount the draft tube-motor assembly is mounted on a frame so that the propeller impeller is submerged in the water, while the draft tube aperture, bearing box and motor are in the air. It is a further subsidiary object of the invention that the frame is pivotable from a horizontal position with propeller, shroud, shaft, draft tube, bearing box and motor above water, to an angled position with propeller and shroud submerged. It is a further subsidiary object of the invention to provide the frame mounted on a raft. It is a further subsidiary object of the invention to provide an electric motor for driving the bearing box. It is a further subsidiary object to provided a raft mounting the frame, propeller, shroud, shaft, draft tube, bearing box and motor, moored in a lagoon. Other objects and advantages of the present invention will become obvious to those skilled in the art, from the following specification, accompanying drawings and appended claims, and it is intended that these objects and advantages are within the scope of the present invention.

To accomplish the above and related objects, this invention may be embodied in the form illustrated in the accompanying drawings, attention being called to the fact, however, that the drawings are illustrative only, not limiting, and that changes may be made in the specific construction illustrated and described within the scope of the appended claims.

In one broad aspect the invention is directed to a draft tube for an impeller extending from a front end for connection to a shroud to accommodate a freely rotating propeller, to a rear end to accommodate a shaft to drive the propeller, and to pass air around the shaft. The tube is straight and has sufficient cross sectional area to permit the shaft and air to pass freely from the rear end to the front end. Generally the draft tube has a side aperture for air ingress toward its rear end. Preferably the draft tube has a rear attachment plate at right angles to the said draft tube. More preferably the side aperture has a stub tube protruding therefrom.

In an alternate broad aspect the invention is directed to a shroud for impeller to accommodate a freely rotating propeller. The shroud has a first aperture of sufficient size to receive a shaft to drive said propeller and to pass air into the shroud around the shaft, and at least one second aperture to pass water into the shroud. The shroud preferably has a front portion for a freely rotating propeller and a rear portion comprising the first aperture axially aligned with the position of the propeller, and the at least one second aperture is rearward of the propeller position. Usually the front portion is cylindrical and the rear portion is a disc which has the first aperture centrally therein. The disc usually has the at least one second aperture therein spaced radially apart from the first aperture. Often there are several second apertures. Conveniently the front portion is joined to the rear portion by a frustroconical mid portion.

In a second broad aspect the invention is directed to a shroud for impeller comprising a front portion for a freely rotating propeller and a rear portion having a first aperture axially aligned with the position of the propeller. The first aperture us of sufficient size to receive a shaft to drive the propeller and to pass air into the shroud around the shaft, and at least one second aperture in the shroud rearward of the propeller position to pass water into the shroud. A draft tube extends rearward from the rear portion and the first aperture. The draft tube is axially aligned with the position of the propeller, and of sufficient size to accommodate the shaft and to pass air into the shroud. Usually the at least one second aperture is rearward of said propeller position. Typically the tube and first aperture have the same i.d. The draft tube usually has a side aperture for air ingress toward its rear end. The draft tube usually has a rear attachment plate at right angles to the draft tube. Typically the draft tube has a stub tube protruding therefrom. The shroud typically has a front cylindrical portion and a rear disc portion, which has the first aperture centrally therein, and also the at least one second aperture therein spaced radially apart from the first aperture. Often there are several second apertures. Conveniently the front portion is joined to the rear portion by a frustroconical mid portion.

In a further broad aspect the invention is directed to an impeller for aeration comprising in combination front to rear shroud, propeller, propeller shaft, draft tube and motor. The propeller shaft is driven by the motor and passes through the draft tube to drive the propeller in the shroud. The propeller shaft is generally coupled by a socket in the propeller shaft which snugly receives the motor shaft, the motor shaft is usually secured in the socket by set screws. The shroud has a first aperture for the propeller shaft and air ingress into the shroud around the shaft, and at least one second aperture for water ingress into the shroud. The draft tube has a side aperture for air ingress toward its rear. Usually the front portion is cylindrical to accommodate ther propeller and the rear portion is a disc which has the first aperture centrally therein. The disc usually has the at least one second aperture therein spaced radially apart from the first aperture. Often there are several second apertures. Conveniently the front portion is joined to the rear portion by a frustroconical mid portion. The draft tube usually has a rear attachment plate at right angles to the draft tube. Typically the draft tube has a stub tube protruding therefrom. The impeller usually additionally comprising a bearing box between the draft tube and the motor. The bearing box contains a bearing for the shaft, which passes through the bearing box, and the bearing. Suitably the impeller is mounted by its bearing box on a swivel arm pivotally mounted on a frame, which itself is mounted on a floatable substrate, typically a raft. It can also be pivotally or fixedly mounted on a fixed substrate. Usually the front portion of the shroud is cylindrical to accommodate ther propeller and the rear portion is a disc which has the first aperture centrally therein. The disc usually has the at least one second aperture therein spaced radially apart from the first aperture. Often there are several second apertures. Conveniently the front portion is joined to the rear portion by a frustroconical mid portion. The draft tube usually has a rear attachment plate at right angles to the draft tube. Typically the draft tube has a stub tube protruding from the side aperture. The bearing box, when present, is attached at its front to ther draft tube by the attachment plate. The bearing is held within the bearing box by a retainer. The motor is mounted upon a motor mount plate attached to the bearing box at its rear. The impeller can be mounted by its bearing box on a swivel arm pivotally mounted on a frame. The frame itself is preferably mounted on paired parallel pontoons. The impeller is mounted on the frame between and parallel to the pontoons. The impeller is pivotable angularly through a right angle from horizontal to vertical through a plurality of angular positions. The swivel arm has mounted thereon an adjustment arm at right angles to the swivel arm and at right angles to the impeller. The frame has mounted thereon an adjustment plate cooperating with the adjustment arm. The adjustment arm has a single aperture. The adjustment plate has a plurality of apertures corresponding to the angular positions of the impeller, each aperture is registrable with the adjustment arm aperture. The impeller can be secured in angular position by passing a retaining pin through the adjustment arm aperture and one of the adjustment plate apertures.

Nearly all elements of shroud, shaft, draft tube bearing box, swivel arm and frame are preferably stainless steel, except the propeller which is aluminum.

### BRIEF DESCRIPTION OF THE DRAWINGS

FIG. 1 shows a longitudinal cross sectional view of a shroud and attached draft tube of an embodiment of the invention.

FIG. 2 shows a front view of a shroud of the embodiment of FIG. 1.

FIG. 3 shows a partial cross sectional view of an assembled impeller of the invention incorporating the embodiment of FIG. 1.

FIG. 4 shows a side elevational view of an aerator of the invention incorporating the embodiment of FIG. 3.

FIG. 5 shows a top plan of the embodiment of FIG. 4.

FIG. 6 shows a front elevational view of the embodiment of FIG. 4.

FIG. 7 shows details of angle adjustment of the embodiment of FIG. 4.

FIG. 8 shows a side cross sectional view of the shaft coupling of FIG. 4.

### DESCRIPTION OF THE PREFERRED EMBODIMENTS

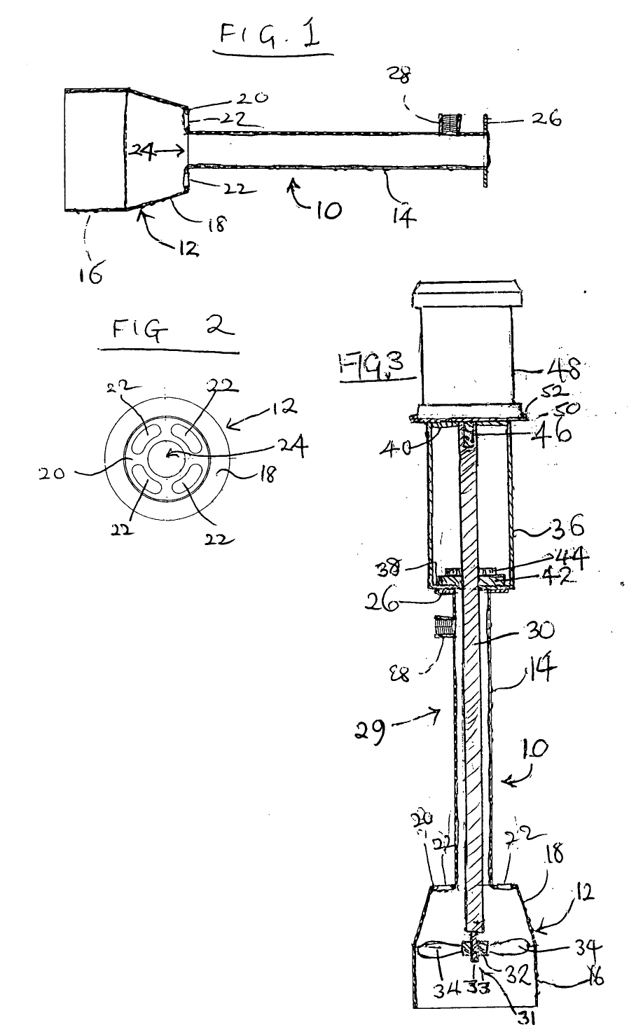

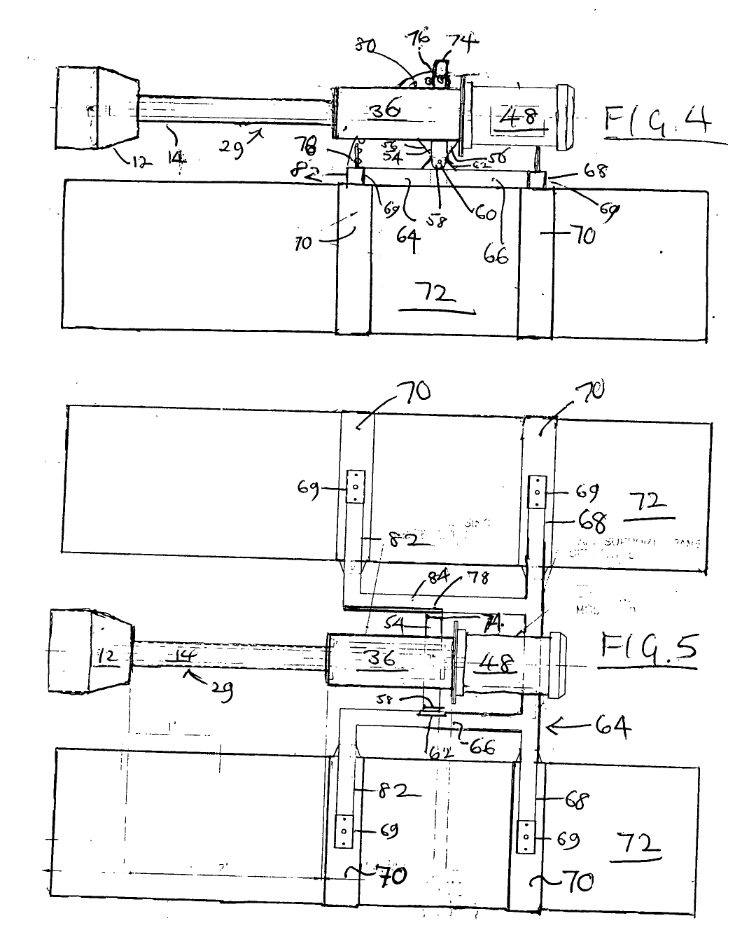

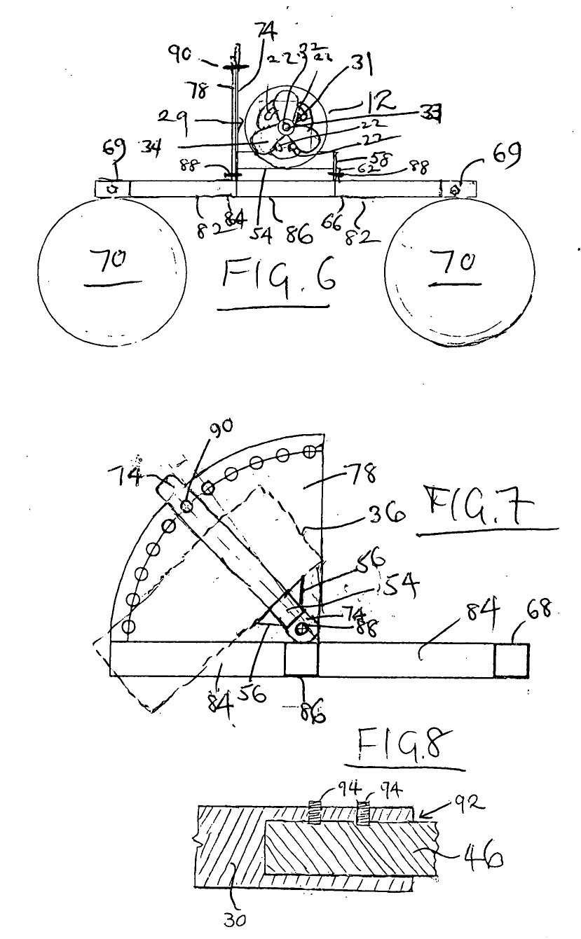

Numeral 10 indicates shroud 12 with attached draft tube 14 of an embodiment of the invention. Shroud 12 has forward cylindrical portion 16, 10″ diameter, 5″ deep, middle frusto conical portion 18 10″ forward diameter tapering to 7″ rear diameter, also 5″ deep and rear disc portion 20 with water access slots 22 and rear draft tube access aperture 24. Water access slots 22 are made by drilling eight 1″ diameter apertures equispaced around draft tube access aperture 24, centered on a circle 5⅛″ diameter, adjacent pairs are then joined to form slots 22. Draft tube 14 has 3″ o.d., 2¾″ i.d., and is 2′ long excluding or including rear plate 26, which is 5½″ or 5⅞″ square and ¼″ or ⅜″ thick, which has corner apertures for attachment to a bearing box. Centered 2¼″ or 3″ forward from the rear end of draft tube 24 is threaded pipe ferrule 28, 1″ diameter and projecting ¾″, for air access. When assembled impeller 29 has shroud 12, containing propeller 31 with hub 32 and blades or vanes 34, hub 32 is mounted on threaded spindle 33 of drive shaft 30. Propeller 31 is a Michigan Machine #012109 9X9 three-bladed propeller of diameter 9 inches. Shaft 30 extends through draft tube 14 into bearing box 36. Shaft 30 is about 45¾″ long, including spindle 33, 4″ long, the bulk of the shaft is 1¾″ diameter. Bearing box 36 is 6½″ square in cross section and extends about 1′3″ along shaft 30, it is of 12 gauge steel plate and has a front or lower end plate 38 for attachment to draft tube attachment plate 26 and a rear or upper end plate 40 for attachment of motor 48, it also has a side removable access plate, not shown. Shaft 30 is contained in bearing 42 held in place by retainer 44, note that bearing 42 avoids the necessity of having an end bearing in shroud 12 for shaft 30, which would virtually eliminate the suction effect of propeller 31. Shaft 30 narrows slightly in bearing box 36 to 1 45/64″ diameter, at its upper or rear end it engages motor drive shaft 46, 3″ long, 1⅛″ diameter, secured by set screws 94 in fitted socket 92, of i.d. 1.127″ (FIG. 8), which is conventional. Motor 48 is attached to circular motor mount plate 50, 10″ diameter, 3/16″ thick, with circumferential flange projecting 3/16″ and ¼″ thick, forming a recess to receive attachably motor 48. Plate 50 is itself attached to plate 40 of bearing box 36. Motor 48 is a Siemens Model F038, electric motor, which is a 5 horsepower, 220 volt motor. A single or three phase electric motor are interchangeably usable in the impeller. Impeller 29 (FIGS. 4 and 5) including shroud 12, draft tube 14, bearing box 36 and motor 48 is mounted on swivel arm 54, a 2″ square, 0.1″ thick metal tube, 1′ long, attached to bearing box 36 by right triangular gusset plates 56, of side 1½″ and thickness ¼″, a pair at each side of bearing box 36. On one end of swivel arm 54 is end plate 58 which projects downward to accommodate pivot hole 60, ¾″ diameter, plate 58 is 2″ across by 3½″ deep by ¼″ thick. On the other end of swivel arm 54 is adjustment arm 74 which extends 1′ 3½″ from top to bottom, is 2″ wide and either ¼″ or ½″ the bottom corresponds to plate 58, but the rest extends upward as shown. Besides another corresponding pivot hole 60, diameter ¾″, at the top is adjustment hole 76, ¾″ diameter, which can correspond with any of eleven adjustment holes 80, ¾″ diameter, spaced at about 80 apart, in adjustment plate 78, itself of radius 1′. Swivel arm 54 engages support frame 64 by pivot pins or a pivot axle passing through pivot holes 60 and corresponding pivot hole, ⅝″ diameter, in trapezoidal support bracket 62, 3″ long, 1½″ tall and ¼″ thick, mounted on longitudinal support bar 66 of support frame 64, and an equivalent ⅝″ diameter hole in adjustment plate 78. Transverse support bars 68 and 82 engage pontoon brackets 69, and are secured to them by threaded bolts and nuts. Frame 64 consists of 2″ square tubing, 0.1″ thick, it has main transverse bar 68, 3′10″ long, longitudinal bars 66 and 84, stump transverse bars 82, and cross support bar 86 (hidden in FIGS. 4 and 5, but visible in FIG. 6). Trapezoidal bracket 62 is mounted on support bar 66, and adjustment plate 78 is similarly mounted on support bar 84. Pontoon brackets 69, 2¼″ square, 0.1″ thick and 4″ long, which receive the ends of support bars 68 and 82, are secured to pontoon support rings 70, 4″ wide, ⅛″ thick, which encircle pontoons 72, which are 7½′ long, 1½′ diameter of plastic, polyethylene preferred. Transverse support bars 68 and 82 project 1′3″ beyond longitudinal bars 66 and 84, which are spaced 1′ apart. All elements including but not limited to support frame 64, shroud 12, draft tube 14, bearing box 36, shaft 30, pontoon support rings 70, etc., are stainless steel, in view of the corrosive nature of lagoons treated, an exception is propeller 31 which is aluminum. As shown in FIG. 6, cross support bar 86 extends from support bar 66 to support bar 84, while swivel arm 64 is parallel and above cross bar 86. Pivot pins 88 pass through end plate 58, which is attached to swivel arm 54, then bracket 62 of support bar 66, and also through adjustment arm 74, which is attached to swivel arm 54, then adjustment plate 78 attached to support bar 84, thus providing a pivot for impeller 29. Lock pin 90 passing through adjustment arm 74 by adjustment hole 76 and adjustment plate 78 by one of eleven holes 80 allows impeller 29 to be held at a predetermined angle for transport or use. FIG. 7 shows the angle adjustment in detail, as shown adjustment arm 74 is at an angle of 45° to the vertical, rotated about pivot pin 88 passing through an aperture in the bottom end of adjustment arm 74 and an equivalent aperture in adjustment plate 78, the top end of adjustment arm 74 is secured by lock pin 90 passing through the 45° angle hole 80 in adjustment plate 78 and equivalent adjustment hole 76 in adjustment arm 74. Swivel arm 54 is welded to adjustment arm 76 and moves with adjustment arm 76. Bearing box 36 shown in ghost, is welded directly to swivel arm 54 and indirectly through gusset plates 56. Thus angling adjustment arm 76 angles bearing box 36, and hence impeller 29. Although the floating support is described in detail, those skilled in the art would appreciate that any practical floating support can be used, and impeller 29 can be mounted on a fixed support either in the middle of the body of water, or at its edge, such as but not limited to a bank, shore, jetty and the like. All these given dimensions are intended to be taken as a general guide to those skilled in the art, and it is understood these may be varied as practice dictates or minor improvements indicate.

In use the shroud bottom is typically between 1′ and 1½′ below water level. The propeller turns at 1750 rpm, the set speed of the motor, which is not adjustable, and as a result there is essentially no water in the draft tube. As a further result the propeller does not seize, because there is no water in the draft tube to freeze, the water in the shroud being in constant motion also does not freeze. The impeller operates reliably down to at least −30° C. or −31° C. without freezing, a significant advantage in much of North America. It aerates through 5 or 6″ of ice, producing a frozen white foam in the hole through the ice. In time this frozen foam covers the entire aerator, including draft tube and motor, resembling an igloo, through which the motor can be heard humming away. It is believed that as air incoming through the draft tube is at −30° C. or −31° C., while the water in the shroud is probably between 0 and 4° C., that the turning of the drive shaft, at about 1750 rpm, in the draft tube prevents freezing and seizing of the impeller. The device was observed to seize at −38° C. In warmer weather, when there is no surface ice, the impeller generates a foam which eventually dissipates covering the entire lagoon with a white foam about ¼″ thick or deep. After prolonged use the lagoon gives positive oxygen readings using an oxygen reading device, no positive oxygen readings were noted when testing the truck wash lagoon before aeration. No competitor's aerator was observed to produce the same amount of foam as of the impeller of the invention, nor was one as effective as instant impeller to applicants' knowledge. Larger 20 or 25 horsepower aerators produced patches of foam around the aerators, but didn't cover the slough. It is believed that the smaller bubbles of instant impeller produce much better aeration than the larger bubbles observed in other aerators. It is also considered that the motor shaft-propeller shaft coupling and the bearing box coupling which greatly reduce vibration and hence bearing wear, avoids the need for a bearing in the impeller shroud, which if present would incommode aeration by the propeller. Such bearings are normally a sleeve mounted by vanes in the shroud, which obviously affects the flow around the propeller. It is also believed that the air flowing down the draft tube is evenly distributed by the propeller in the shroud, and that the absence of bearings in the propeller enhances air flow which is central around the shaft, better distributed and creates better suction. Similarly the water flows evenly into the shroud and mixes better with the air to produce a foam, some of which dissolves into and aerates the water surrounding the shroud.

As those skilled in the art would realize these preferred described details and materials and components can be subjected to substantial variation, modification, change, alteration, and substitution without affecting or modifying the function of the described embodiments.

Although embodiments of the invention have been described above, it is not limited thereto, and it will be apparent to persons skilled in the art that numerous modifications and variations form part of the present invention insofar as they do not depart from the spirit, nature and scope of the claimed and described invention.

I claim:

1. Draft tube for impeller extending from a front end for connection to a shroud to accommodate a freely rotating propeller, to a rear end to accommodate a shaft to drive said propeller, and to pass air around said shaft, said tube being straight and having sufficient cross sectional area to permit said shaft and air to pass freely from said rear end to said front end.

2. Draft tube of claim 1, wherein said draft tube has a side aperture for air ingress toward its rear end.

3. Draft tube of claim 2, wherein said draft tube has a rear attachment plate at right angles to said draft tube.

4. Draft tube of claim 3, wherein said side aperture has a stub tube protruding therefrom.

5. Shroud for impeller comprising a front portion for a freely rotating propeller and a rear portion having a first aperture axially aligned with the position of said propeller, said first aperture being of sufficient size to receive a shaft to drive said propeller and to pass air into said shroud around said shaft, and at least one second aperture in said shroud to pass water into said shroud, and a draft tube extending rearward from said rear portion and said first aperture, said draft tube being axially aligned with said position of said propeller, and of sufficient size to accommodate said shaft and to pass air into said shroud.

6. Shroud of claim 5 wherein said at least one second aperture is rearward of said propeller position.

7. Shroud of claim 6, wherein said front portion is cylindrical and said rear portion is a disc having said first aperture centrally therein.

8. Shroud of claim 7, wherein said disc has said at least one second aperture therein spaced radially apart from said first aperture.

9. Shroud of claim 8, wherein said front portion is joined to said rear portion by a frustroconical mid portion.

10. Shroud of claim 9, wherein said draft tube has a side aperture for air ingress toward its rear end, and said side aperture has a stub tube protruding therefrom, and wherein said draft tube has a rear attachment plate at right angles to said draft tube.

11. Impeller for aeration comprising in combination front to rear shroud, propeller, propeller shaft, draft tube and motor, said propeller shaft being driven by said motor and passing through said draft tube to drive said propeller in said shroud, said shroud having a first aperture for said propeller shaft and air ingress into said shroud around said shaft, and at least one second aperture for water ingress into said shroud, said draft tube having a side aperture for air ingress toward its rear.

12. Impeller of claim 11, wherein said shroud has a front cylindrical portion to accommodate said propeller and a rear disc portion having said first aperture centrally therein.

13. Impeller of claim 3, wherein said disc portion has said at least one second aperture therein spaced radially apart from said first aperture.

14. Impeller of claim 13, wherein in said shroud, said front portion is joined to said rear portion by a frustroconical mid portion.

15. Impeller of claim 11, wherein said draft tube has a rear attachment plate at right angles to said draft tube.

16. Impeller of claim 15, wherein said side aperture of said draft tube has a stub tube protruding therefrom.

17. Impeller of claim 11 additionally comprising a bearing box between said draft tube and said motor, said bearing box containing a bearing for said shaft, said shaft passing through said bearing box, and said bearing.

18. Impeller of claim 17 wherein said impeller is mounted by its bearing box on a swivel arm pivotally mounted on a frame, said frame being mounted on a floatable substrate.

19. Impeller of claim 17, wherein said shroud has a front cylindrical portion to accommodate said propeller and a rear disc portion having said first aperture centrally therein, and said disc portion has said at least one second aperture therein spaced radially apart from said first aperture, and said front portion is joined to said rear portion by a frustroconical mid portion, and
said draft tube has a rear attachment plate at right angles to said draft tube, and said side aperture of said draft tube has a stub tube protruding therefrom, and
said bearing box is attached at its front to said draft tube by said attachment plate, and said bearing is held within said bearing box by a retainer, and said motor is mounted upon a motor mount plate attached to said bearing box at its rear.

20. Impeller of claim 19 wherein said impeller is mounted by its bearing box on a swivel arm pivotally mounted on a frame, said frame being mounted on paired parallel pontoons, said impeller being mounted on said frame between and parallel to said pontoons said impeller being pivotable angularly through a right angle from horizontal to vertical through a plurality of angular positions, said swivel arm having mounted thereon an adjustment arm at right angles to said swivel arm and at right angles to said impeller, said frame having mounted thereon an adjustment plate cooperating with said adjustment arm, said adjustment arm having a single aperture, said adjustment plate having a plurality of apertures corresponding to said angular positions of said impeller, each aperture being registrable with said adjustment arm aperture, whereby said impeller can be secured in angular position by passing a retaining pin through said adjustment arm aperture and one of said adjustment plate apertures.
